(19) United States
(12) Patent Application Publication
(10) Pub. No.: US 2015/0285471 A1
(43) Pub. Date: Oct. 8, 2015

(54) LIGHT MECHANISM

(71) Applicant: Jen Shieh SHIH, Changhua (TW)

(72) Inventor: Jen Shieh SHIH, Changhua (TW)

(73) Assignee: Jen Shieh SHIH, Changhua (TW)

(21) Appl. No.: 14/243,021

(22) Filed: Apr. 2, 2014

(51) Int. Cl. F21V 19/00; F21V 29/50

(52) U.S. Cl. CPC F21V 19/003; F21V 29/50; F21Y 2101/02

(57) ABSTRACT

A light mechanism includes a housing having a peripheral fence, a casing engaged onto the housing and having two inclined surfaces oppositely formed in an upper portion of the casing and faced away from each other, a circuit board attached to the inclined surfaces of the casing and having a light element, and a cover engaged onto the casing and the circuit board for retaining the circuit board to the casing, and the cover includes two tongues engaged with the housing for securing the casing and the circuit board to the housing, the cover includes two openings for engaging with the circuit board and the casing and includes one or more passages communicating with the opening and the compartment of the cover for heat dissipating purposes.

### BACKGROUND OF THE INVENTION

1. Field of the Invention

The present invention relates to a light emitting diode (LED) light mechanism, and more particularly to an LED light mechanism including a structure for allowing the light mechanism to be easily and quickly assembled and including a structure for allowing the heat generated by the light element to be suitably dissipated and for allowing the working life of the light element to be suitably increased.

2. Description of the Prior Art

Typical light devices or light mechanisms or light facilities comprise one or more batteries disposed in a receptacle and coupled to one or more light bulbs, such as light emitting diodes (LEDs) light bulbs for energizing the light bulbs and for actuating or operating the light bulbs to generate the indicating light or the flash light or the like.

For example, U.S. Pat. No. 4,368,507 to Reynolds, U.S. Pat. No. 5,154,600 to Sylvestre, and U.S. Pat. No. 5,483,956 to Shapiro disclose three of the typical flashlights, illumination kits, or night lights, and each comprising a supporting case or body for receiving or accommodating one or more LED light bulbs, and a battery coupled to the light bulbs for energizing the light bulbs to generate various lights or flashlights.

However, the LED light bulbs of the typical flashlights, illumination kits, or night lights may generate a great heat while in use, and the LED light bulbs are normally received or accommodated within the supporting case or body, and the heat normally may not be easily dissipated such that the working life of the light elements or light bulbs may be decreased by the heat generated by the LED light bulbs.

The present invention has arisen to mitigate and/or obviate the afore-described disadvantages of the conventional light devices or facilities.

### SUMMARY OF THE INVENTION

The primary objective of the present invention is to provide a light mechanism including a structure for allowing the light mechanism to be easily and quickly assembled.

The other objective of the present invention is to provide a light mechanism including a structure for allowing the heat generated by the light element to be suitably dissipated and for allowing the working life of the light element to be suitably increased.

In accordance with one aspect of the invention, there is provided a light mechanism comprising a housing including a peripheral fence extended upwardly from the housing for forming a chamber in the housing, a casing engaged onto the housing and including two inclined surfaces oppositely formed in an upper portion of the casing and faced away from each other to form an inverted V-shaped structures, a circuit board attached to the inclined surfaces of the casing respectively, at least one light element attached to the circuit board for generating a light, and a cover engaged onto the casing and engaged onto the circuit board for covering and retaining the circuit board to the casing, and the cover including a compartment formed therein for receiving and engaging with the circuit board and the casing, and including two tongues engaged with the housing for securing the casing and the circuit board to the housing, the cover including two openings oppositely formed therein and communicating with the compartment of the cover for engaging with the circuit board and the casing and for anchoring and positioning the circuit board and the casing to the housing.

The housing includes two ears extended from the peripheral fence, and the tongues of the cover are engaged with the ears of the housing for securing the cover to the housing. The housing includes an orifice formed in each of the ears, and the cover includes a catch provided on each of the tongues for engaging with the orifice of the ear and for securing the cover and the circuit board and the casing to the housing.

The cover includes a tilted guiding surface formed in each of the catches for guiding the catches of the cover to engage with the ears of the housing. The casing includes two notches formed therein for receiving or engaging with the ears of the housing and the tongues of the cover respectively and for allowing the tongues of the cover to be detachably engaged with the orifices of the ears of the housing.

The housing includes a chamber formed in the peripheral fence, and a plate member engaged in the chamber of the housing. The housing includes a plug provided thereon, and the plate member includes two prongs extended therefrom and electrically connected to the plug. The cover includes at least one passage formed therein and communicating with the opening and the compartment of the cover for forming heat circulating passages and for heat dissipating purposes.

The cover includes one or more depressions formed in each of the inclined surfaces of the casing for receiving and engaging with the circuit board respectively. The cover includes a hole or cavity formed in each of the inclined surfaces and communicating with the depression of the casing respectively, and the circuit board includes an electric cable or wire engaged through the cavity of the casing for coupling to the batteries or electric reservoir or the like and for energizing the light elements.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a light mechanism in accordance with the present invention;

FIG. 2 is a perspective view of the light mechanism;

FIGS. 3, 4 are perspective views illustrating the other arrangements of the outer supporting housing;

FIG. 5 is a cross sectional view of the light mechanism taken along lines 5-5 of FIG. 2;

FIG. 6 is an enlarged partial cross sectional view of the light mechanism; and

FIGS. 7, 8 are side plan schematic views illustrating the operation of the light mechanism.

### DETAILED DESCRIPTION OF THE PREFERRED EMBODIMENT

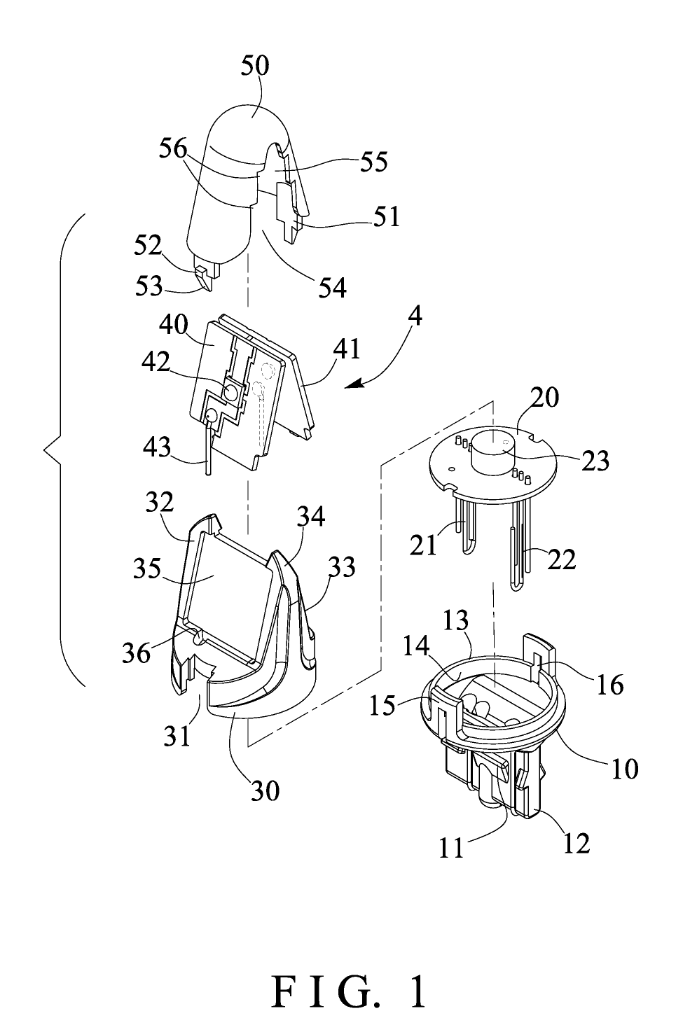

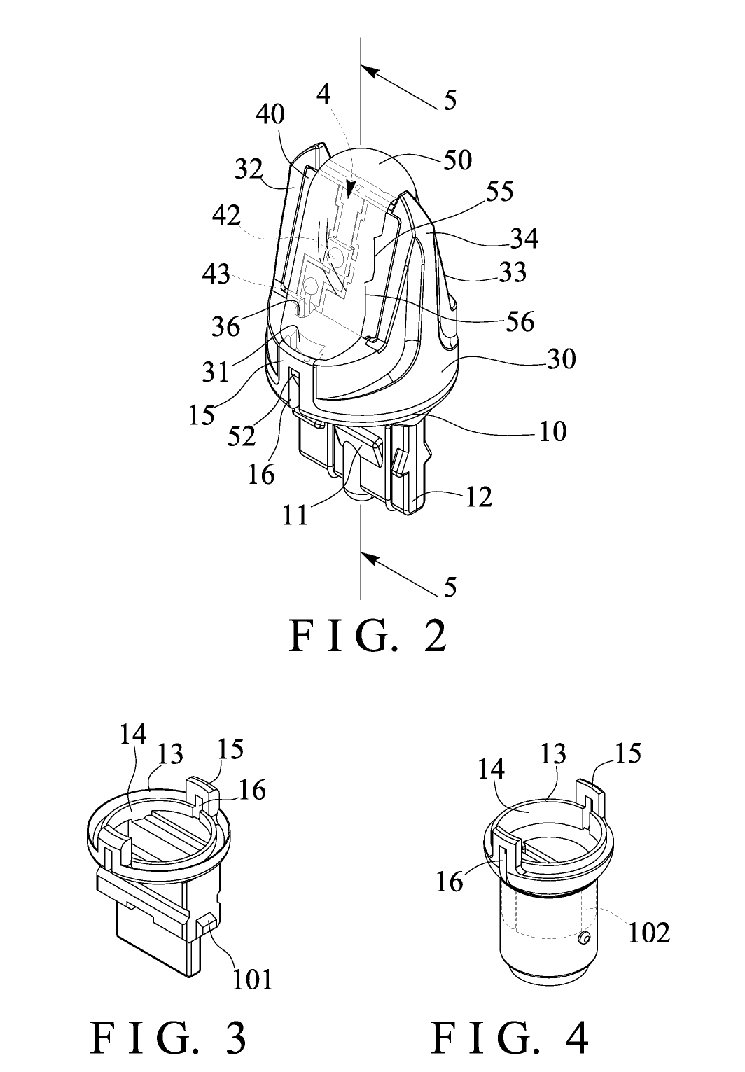

Referring to the drawings, and initially to FIGS. 1-2, a light mechanism in accordance with the present invention comprises an outer supporting receptacle or housing 10 including a terminal or electrode or plug 11 formed or provided on one end or lower portion 12 thereof for plugging or coupling to the typical electrical sockets or the like (not illustrated), and including a peripheral wall or fence 13 extended upwardly therefrom for forming or defining a compartment or chamber 14 in the upper portion of the housing 10 (FIG. 1), and including one or more (such as two) flaps or catches or latches or ears 15 extended from the peripheral fence 13 and preferably arranged or located opposite to each other, and the ears 15 each include a lock slot or latch opening or orifice 16 formed or provided therein and communicating with the chamber 14 of the housing 10 (FIG. 1).

A control device or panel or plate member 20 is disposed or engaged into the chamber 14 of the housing 10, and includes one or more (such as two) terminals or electrodes or prongs 21, 22 extended downwardly therefrom (FIG. 1) and electrically connected or coupled to the plug 11 for connecting or coupling to the electrical socket or power source or power reservoir (not illustrated) and for receiving electric power energy from the reservoir or the like, and includes a battery and/or processor unit or device 23 disposed or supported thereon. As shown in FIGS. 3 and 4, the housing 101, 102 may be formed or shaped into the other shapes or structures or contours or configurations for fitting or engaging with various different electrical devices or mechanisms or facilities (not illustrated).

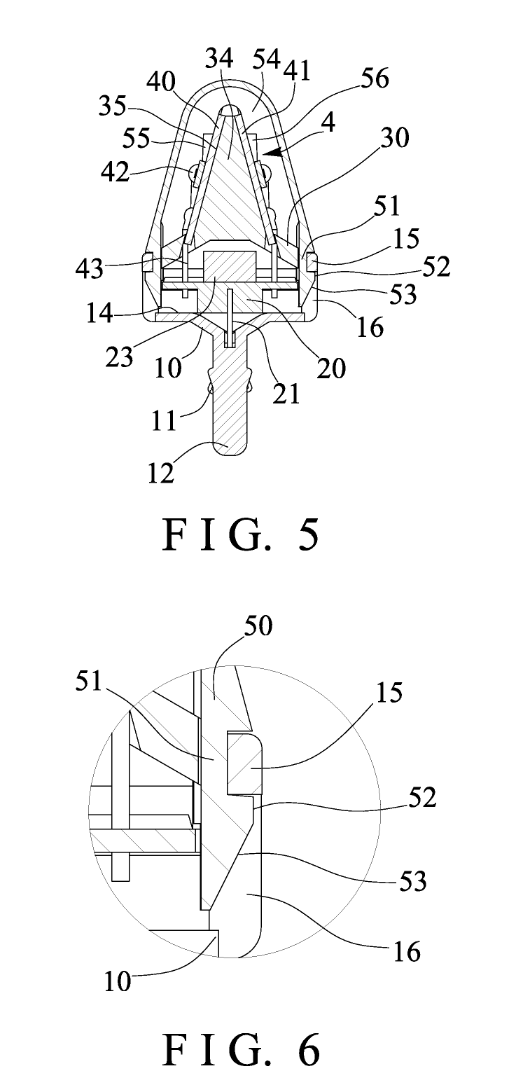

A supporting case or body or casing 30 is disposed or attached or mounted or engaged onto the housing 10 and engaged with the peripheral fence 13 for anchoring or retaining or securing to the casing 30 to the housing 10, the casing 30 includes one or more (such as two) lock slots or latch openings or notches 31 formed or provided therein for fitting or receiving or engaging with the ears 15 of the housing 10 respectively and for anchoring or retaining or securing or positioning the casing 30 to the housing 10 and for preventing the casing 30 from being pivoted or rotated relative to the housing 10, and includes one or more (such as two) tilted or inclined surfaces 32, 33 formed or provided in the upper portion 34 of the casing 30 and faced or directed away from each other, or arranged or located opposite to each other for forming or defining an inverted V-shaped structures or configuration, as shown in FIGS. 5 and 7-8.

The casing 30 further includes a recess or depression 35 formed in each of the inclined surfaces 32, 33 of the casing 30, and includes a cavity 36 formed in each of the inclined surfaces 32, 33 and communicating with the depression 35 of the casing 30 respectively, and a light member or device 4 includes a circuit board 40 having one or more (such as two) panels 41 attached or mounted or engaged into the depressions 35 of the inclined surfaces 32, 33 of the casing 30 respectively, and one or more light bulbs or elements 42, such as light emitting diode (LED) light elements 42 attached or mounted or secured to the panels 41 of the circuit board 40 for generating the indicating light or the flashlight or the like. The casing 30 is preferably made of heat conductive materials, such as aluminum or the like for dissipating the heat that may be generated by the light elements 42.

The light device 4 further includes one or more wires 43 coupled to the circuit board 40 and/or the light elements 42 and engaged through the cavities 36 of the casing 30 for coupling to the processor device 23 and/or the plate member 20 and/or the prongs 21, 22 and for receiving the electric power energy from the electric reservoir and for selectively energizing the light bulbs or light elements 42 to generate various lights or flashlights. The light mechanism includes a shield or hood or cover 50 attached or mounted or engaged onto the casing 30 and engaged onto the panels 41 of the circuit board 40 and the light elements 42 and for shielding or covering and anchoring or retaining or securing the panels 41 of the circuit board 40 to the casing 30, and the cover 50 includes one or more (such as two) tongues 51 for engaging into the notches 31 of the casing 30 respectively.

The cover 50 further includes a latch or catch 52 formed or provided on each of the tongues 51 for engaging with the orifice 16 of the ear 15 of the housing 10 and for solidly and stably attaching or mounting or securing the cover 50 and the panels 41 of the circuit board 40 and the casing 30 to the housing 10, and a tilted or inclined guiding surface 53 formed in each of the catches 52 or the tongues 51 for guiding the catches 52 or the tongues 51 to engage with the ears 15 of the housing 10, and includes a chamber or compartment 54 formed in the cover 50 for partially receiving or engaging with the panels 41 of the circuit board 40 and the casing 30, and includes one or more (such as two) openings 55 oppositely formed therein and communicating with the compartment 54 of the cover 50 for receiving or engaging with the panels 41 of the circuit board 40 and the casing 30 and for anchoring or retaining or securing the panels 41 of the circuit board 40 and the casing 30 to the housing 10.

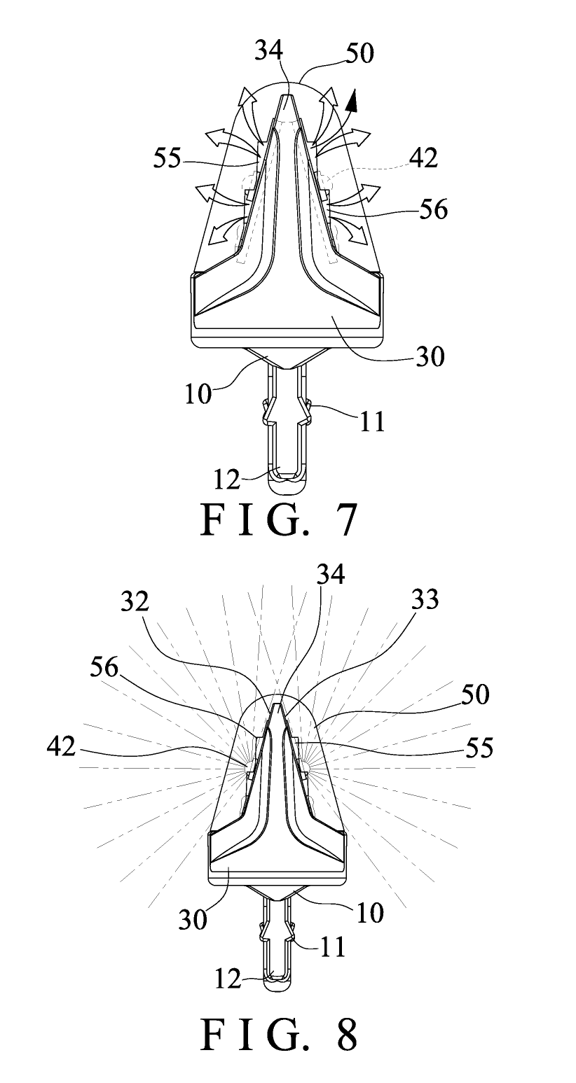

As shown in FIGS. 1-2, 5 and 7-8, the cover 50 further includes one or more slots or openings or notches or apertures or passages 56 formed or provided therein and communicating with the openings 55 and the compartment 54 of the cover 50 respectively and for forming or defining one or more air circulating passages 56 between the cover 50 and the panels 41 of the circuit board 40 and the casing 30, best shown in FIGS. 5 and 7-8, and for allowing the heat that may be generated by the light elements 42 to be flown or dissipated through the air circulating passages 56 of the cover 50 (FIG. 7), and for allowing the working life of the light elements 42 to be suitably increased. As shown in FIG. 8, the cover 50 is made of transparent or semi-transparent materials for allowing the light generated by the light element 42 to be emitted out of the cover 50.

In operation, as shown in FIGS. 2, 5 and 7-8, the panels 41 of the circuit board 40 and the casing 30 may be solidly and stably attached or mounted or secured to the housing 10 with the cover 50, and the formation or provision of the air circulating passages 56 of the cover 50 allows the heat generated by the light elements 42 to be flown or dissipated through the air circulating passages 56 of the cover 50 (FIG. 7), and for allowing the working life of the light elements 42 to be suitably increased. The light generated by the light elements 42 may be emitted out through the transparent or semi-transparent the cover 50 (FIG. 8).

Accordingly, the light mechanism in accordance with the present invention includes a structure for allowing the light mechanism to be easily and quickly assembled and for allowing the heat generated by the light element to be suitably dissipated and for allowing the working life of the light element to be suitably increased.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A light mechanism comprising:
a housing including a peripheral fence extended upwardly from said housing for forming a chamber in said housing,
a casing engaged onto said housing and including two inclined surfaces oppositely formed in an upper portion of said casing and faced away from each other to form an inverted V-shaped structures,
a circuit board attached to said inclined surfaces of said casing respectively,
at least one light element attached to said circuit board for generating a light, and
a cover engaged onto said casing and engaged onto said circuit board for covering and retaining said circuit board to said casing, and said cover including a compartment formed therein for receiving and engaging with said circuit board and said casing, and including two tongues engaged with said housing for securing said casing and said circuit board to said housing, said cover including two openings oppositely formed therein and communicating with said compartment of said cover for engaging with said circuit board and said casing and for anchoring said circuit board and said casing to said housing.

2. The light mechanism as claimed in claim 1, wherein said housing includes two ears extended from said peripheral fence, and said tongues of said cover are engaged with said ears.

3. The light mechanism as claimed in claim 2, wherein said housing includes an orifice formed in each of said ears, and said cover includes a catch provided on each of said tongues for engaging with said orifice of said ear and for securing said cover and said circuit board and said casing to said housing.

4. The light mechanism as claimed in claim 3, wherein said cover includes a tilted guiding surface formed in each of said catches for guiding said catches to engage with said ears.

5. The light mechanism as claimed in claim 3, wherein said casing includes two notches formed therein for engaging with said ears of said housing and said tongues of said cover respectively.

6. The light mechanism as claimed in claim 1, wherein said housing includes a chamber formed in said peripheral fence, and a plate member engaged in said chamber of said housing.

7. The light mechanism as claimed in claim 6, wherein said housing includes a plug provided thereon, and said plate member includes two prongs extended therefrom and electrically connected to said plug.

8. The light mechanism as claimed in claim 1, wherein said cover includes a depression formed in each of said inclined surfaces of said casing for engaging with said circuit board.

9. The light mechanism as claimed in claim 8, wherein said cover includes a cavity formed in each of said inclined surfaces and communicating with said depression of said casing respectively, and said circuit board includes a wire engaged through said cavity of said casing.

10. The light mechanism as claimed in claim 1, wherein said cover includes at least one passage formed therein and communicating with said opening and said compartment of said cover for heat dissipating purposes.
